(19) United States
(12) Patent Application Publication
(10) Pub. No.: US 2024/0320579 A1
(43) Pub. Date: Sep. 26, 2024

(54) PRODUCTION PLANNING DEVICE, PRODUCTION PLANNING METHOD, AND RECORDING MEDIUM

(71) Applicant: TDK Corporation, Tokyo (JP)

(72) Inventors: Akihiro Masuda, Tokyo (JP); Airi Yokoyama, Tokyo (JP); Takaaki Sato, Tokyo (JP)

(73) Assignee: TDK Corporation, Tokyo (JP)

(21) Appl. No.: 18/604,767

(22) Filed: Mar. 14, 2024

(30) Foreign Application Priority Data
Mar. 23, 2023 (JP) 2023-046898
Feb. 27, 2024 (JP) 2024-027751

(51) Int. Cl. G06Q 10/0631

(52) U.S. Cl. CPC G06Q 10/06313

(57) ABSTRACT

A production planning device includes an acquisition unit and a distribution planning unit. The acquisition unit acquires article list information. The article list information includes information regarding a plurality of types of articles. The distribution planning unit creates distribution plan data. The distribution plan data is data for distributing a plurality of types of articles included in the article list information to a plurality of production lines. The distribution planning unit creates distribution plan data based on entropy associated with loss information regarding loss of production process speed in each production line.

### TECHNICAL FIELD

The present invention relates to a production planning device, a production planning method, and a recording medium.

### BACKGROUND

There is a production planning device that creates production plan data of articles. For example, a production planning device disclosed in Japanese Unexamined Patent Publication No. 2016-18434 creates production plan data indicating a procedure of producing a plurality of types of articles. This production planning device acquires information regarding a plurality of types of articles, and creates production plan data based on the acquired information.

In Japanese Unexamined Patent Publication No. 2016-18434, production plan data is created by using a genetic algorithm. In a case where the genetic algorithm is used, for example, a process of creating child data from parent data of production plan data and using the created child data as parent data is repeated. For example, by applying a genetic algorithm to a production order of a plurality of types of articles, production plan data that reduces production throughput can be created.

In a case where a plurality of types of articles are produced in a plurality of production lines, a distribution pattern of the articles to each production line is also related to the production throughput. Thus, it is conceivable to apply a genetic algorithm in consideration of the distribution pattern of the articles to each production line in addition to the production order of the articles. However, in this case, a calculation amount is remarkably increased as compared with a case where production plan data is created in one production line. As a result, it takes unrealistic time to create the production plan data, and practicality may be impaired.

An object of one aspect of the present invention is to provide a production planning device capable of reducing a production throughput even in a case of creating a plurality of types of articles in a plurality of production lines and capable of easily executing a production plan. Another aspect of the present invention is to provide a production planning method capable of reducing a production throughput even in a case of creating a plurality of types of articles in a plurality of production lines, and capable of easily executing a production plan. An object of still another aspect of the present invention is to provide a recording medium capable of reducing a production throughput even in a case where a plurality of types of articles is created in a plurality of production lines, and capable of easily executing a production plan.

### SUMMARY

A production planning device according to one aspect of the present invention includes an acquisition unit and a distribution planning unit. The acquisition unit acquires the article list information. The article list information includes information regarding a plurality of types of articles. The distribution planning unit creates distribution plan data. The distribution plan data is data for distributing a plurality of types of articles included in the article list information to a plurality of production lines. The distribution planning unit creates distribution plan data based on entropy associated with loss information regarding loss of production process speed in each of the production lines.

In this production planning device, the distribution planning unit creates distribution plan data based on entropy. The entropy is associated with loss information regarding loss of production process speed in each of the production lines. As described above, the entropy is associated with the loss information regarding the loss of the production process speed, and the distribution plan data is created based on the entropy. Thus, distribution plan data in which a production throughput is reduced while a calculation amount is curbed is created. Therefore, even in a case where a plurality of types of articles are created in a plurality of production lines, a production plan that can reduce the production throughput can be easily executed.

In the one aspect, the loss information may include the number of the articles of each type to be distributed to each of the production lines. The entropy may be associated with the number of the articles of each type to be distributed to each of the production lines. In this case, distribution plan data in which the production throughput is easily and reliably reduced is created.

In the one aspect, the distribution planning unit may create the distribution plan data based on an enthalpy associated with a total number of the plurality of types of articles to be distributed to the respective production lines and on the entropy. In this case, distribution plan data in which the production throughput is more easily and reliably reduced is created.

In the one aspect, the distribution planning unit may include a time calculation unit and a distribution calculation unit. The time calculation unit may calculate a predicted processing time of the plurality of types of articles distributed to each production line. The distribution calculation unit may calculate a distribution pattern for distributing the plurality of types of articles included in the article list information to of the plurality of respective production lines, based on the predicted processing time calculated by the time calculation unit. The time calculation unit may calculate the predicted processing time based on the entropy and the enthalpy. In this case, distribution plan data in which the production throughput is more easily and reliably reduced is created.

In the one aspect, the distribution calculation unit may calculate a sum and a variance of the predicted processing times for the plurality of production lines and, based on the calculated results, calculates a distribution pattern for distributing the plurality of types of articles included in the article list information to the respective production lines. In this case, distribution plan data in which the production throughput is more easily and reliably reduced is created.

In the one aspect, in each of the plurality of production lines, the time calculation unit may calculate the predicted processing time such that Time_{pred}=H/v_{pred} and v_{pred}=vₘₐₓ(G/H) are satisfied. In this case, the predicted processing time in each of the plurality of production lines may be denoted by “Time_{pred}”. A predicted processing speed of the plurality of types of articles distributed to each production line may be denoted by “v_{pred}”. The maximum processing speed in each production line may be denoted by “vₘₐₓ”. The enthalpy in each production line may be denoted by “H”. Gibbs energy calculated from the entropy and the enthalpy in each production line may be denoted by “G”. In this case, the predicted processing time is more easily calculated.

In the one aspect, in each of the plurality of production lines, the time calculation unit may calculate the predicted processing time such that Time_{pred}=Time_{ideal}+Timeₗₒₛₛ, Time_{ideal}=Σ(Nᵢ/vᵢ), and Timeₗₒₛₛ=ΣXⱼSⱼ are satisfied. In this case, the predicted processing times in each of the production lines may be denoted by “Time_{pred}”. An ideal processing time in each of the production lines may be dented by “Time_{ideal}”. A loss time in each of the production lines may be denoted by“Timeₗₒₛₛ”. A total number of an i-th type of article among the plurality of types of articles to be distributed to the respective production lines may be denoted by “Nᵢ”. A predicted processing speed of an i-th type of article among the plurality of types of articles to be distributed to the respective production lines may be denoted by “vᵢ”. A coefficient of j-th parameter among a plurality of types of parameters specifying each of the plurality of types of articles to be distributed to the respective production lines may be denoted by “Xⱼ”. The entropy corresponding to a j-th parameter among the plurality of types of parameters may be denoted by “Sⱼ”. In this case, the predicted processing time is more easily calculated.

In the one aspect, the article list information may include parameter information indicating at least one value of each of parameters and the parameters are a plurality of types of parameters respectively specifying the plurality of types of articles. The loss information may include, for every type of the at least one value of each of the parameters, the number of at least one value. The distribution planning unit may create the distribution plan data based on entropy associated with the number of the at least one value for every type of the at least one value of each of a plurality of the parameters included in the plurality of types of parameters. In this case, distribution plan data in which the production throughput is more easily and reliably reduced is created.

In the one aspect, the production planning device may further include a parameter extraction unit. The parameter extraction unit may extract a plurality of parameters from the plurality of types of parameters, based on correlation information between the plurality of types of parameters. The distribution planning unit may create the distribution plan data based on entropy associated with the number of at least one value, for each of the parameters extracted by the parameter extraction unit. In this case, distribution plan data in which the production throughput is more easily and reliably reduced is created.

In the one aspect, the parameter extraction unit may extract the parameter included in a second combination having a correlation coefficient lower than a correlation coefficient of a first combination among the plurality of types of parameters. In this case, distribution plan data in which the production throughput is more easily and reliably reduced is created.

A production planning method according to another aspect of the present invention includes acquiring article list information including information regarding a plurality of types of articles and creating distribution plan data. The distribution plan data is data for distributing a plurality of types of articles included in the article list information to a plurality of production lines. The distribution plan data is created based on entropy associated with loss information regarding loss of production process speed in each production line.

A recording medium according to still another aspect of the present invention is a computer-readable recording medium storing a program for use in an electromagnetic environment analysis method. When executed by a processor, the program causes a computer to execute acquiring article list information including information regarding a plurality of types of articles and creating distribution plan data. The distribution plan data is data for distributing a plurality of types of articles included in the article list information to a plurality of production lines. The distribution plan data is created based on entropy associated with loss information regarding loss of production process speed in each production line.

The present invention will become more fully understood from the detailed description given hereinafter and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a block diagram of a production planning device according to the present embodiment;

FIG. 2 is a conceptual diagram illustrating distribution of articles to a plurality of production lines;

FIG. 3 is a table illustrating production process parameters of an article;

FIG. 4 is a conceptual diagram illustrating a processing time of an article to be processed on a production line;

FIG. 5 is a correlation diagram between an average production speed and entropy;

FIG. 6 is a correlation diagram of average production speed, entropy, and enthalpy;

FIG. 7 is a correlation diagram between an average production speed and a predicted processing speed in the present embodiment;

FIG. 8 is a flowchart illustrating an example of a production planning method;

FIG. 9 is a flowchart illustrating an example of a distribution planning process;

FIG. 10 is a flowchart illustrating an example of a distribution planning process according to a modification example of the present embodiment;

FIG. 11 is a block diagram of a production planning device according to a modification example of the present embodiment;

FIG. 12 is a table illustrating parameters of an article;

FIG. 13 is a diagram illustrating a correlation of parameters of an article;

FIG. 14 is a flowchart illustrating an example of a production planning method according to a modification example of the present embodiment;

FIG. 15 is a correlation diagram between a sum of switching times obtained by a genetic algorithm and a sum of switching times calculated thermodynamically;

FIG. 16 is a diagram illustrating an example of a hardware configuration of the production planning device;

FIG. 17 is a gantry chart of a plurality of production lines of production plan data in a comparative example;

FIG. 18 is a gantry chart of a plurality of production lines of production plan data in the example described in the present embodiment;

FIG. 19 is a graph for comparing a total predicted processing time between the example described in the present embodiment and the comparative example; and

FIG. 20 is a graph for comparing a variance of the predicted processing time between the example described in the present embodiment and the comparative example.

### DETAILED DESCRIPTION

Hereinafter, embodiments of the present invention will be described in detail with reference to the accompanying drawings. In the description of the drawings, the same reference numerals are used for the same or equivalent elements, and redundant description will be omitted.

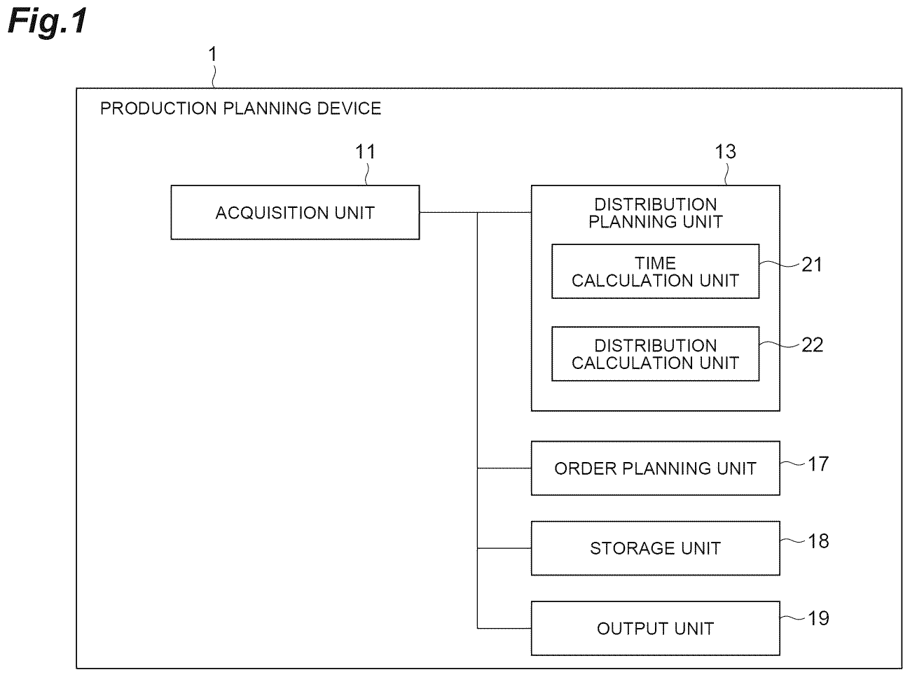

First, a function and a configuration of a production planning device according to the present embodiment will be described with reference to FIG. 1. FIG. 1 is a block diagram of a production planning device. A production planning device 1 creates production plan data of a plurality of types of articles and prepares a production plan. An “article” is, for example, a product of which production is planned by the production planning device 1. The production planning device 1 creates, for example, production plan data of electronic components. The electronic components may be, for example, radial electronic components.

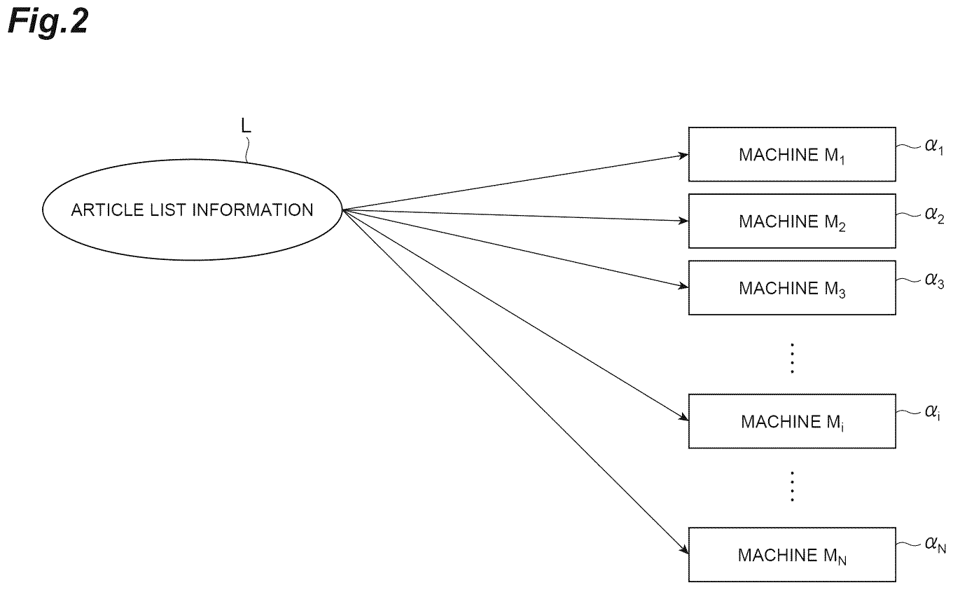

The production planning device 1 prepares a distribution plan for distributing a plurality of types of articles to a plurality of production lines. The production plan data created by the production planning device 1 includes a distribution pattern for distributing a plurality of types of articles to a plurality of production lines. FIG. 2 is a conceptual diagram illustrating distribution of articles to a plurality of production lines. For example, as illustrated in FIG. 2, a plurality of types of articles included in the article list information L are distributed to a plurality of production lines α₁ to αN. For example, the production lines α₁ to α_{N} respectively include machines M₁ to M_{N}, and execute a production process of the distributed articles different from each other. The distribution pattern created by the production planning device 1 indicates to which of the production lines α₁ to α_{N} the plurality of types of articles included in article list information L are respectively to be distributed.

In the example described in the present embodiment, the production planning device 1 further prepares an order plan regarding the order of creating articles in the production lines. In this case, the production plan data created by the production planning device 1 further includes an order pattern for creating articles in the production lines.

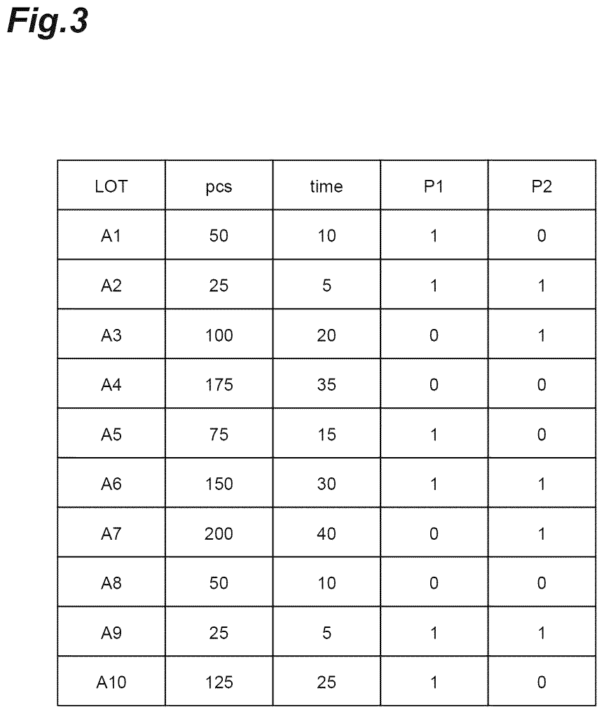

FIG. 3 is a table illustrating production process parameters of an article. For example, in production lines, a process of producing a plurality of lots A₁ to A₁₀ is executed. The plurality of lots A₁ to A₁₀ include different types of articles, and the same lot includes the same type of article. Each of the lots A₁ to A₁₀ includes a plurality of articles. FIG. 3 illustrates the number of articles PCS, a production process time “time” required for the production process of one article, and the presence or absence of parameters P1 and P2 in the production process of each lot in each of the lots A₁ to A₁₀. The parameters P1 and P2 are, for example, features of articles included in a lot, components used in a production process, or tools used in a production process. In the table illustrated in FIG. 3, “1” of the parameters P1 and P2 indicates that the parameters P1 and P2 are included, and “0” of the parameters P1 and P2 indicates that the parameters P1 and P2 are not included.

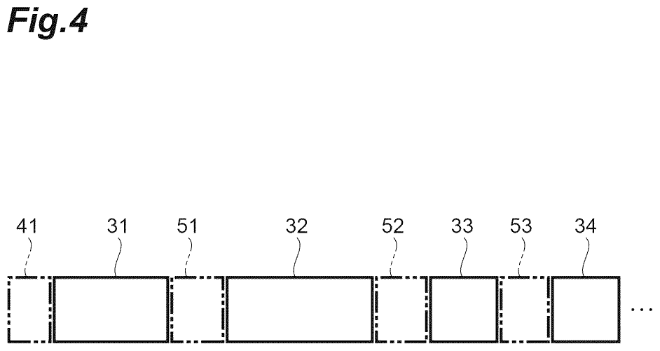

FIG. 4 is a conceptual diagram illustrating a processing time of an article to be processed in a production line. In FIG. 4, lot processing times 31, 32, 33, and 34 respectively indicate production process times required for production processes of lots. Each of the lot processing times 31, 32, 33, and 34 indicates a production process time of at least one article of the lots A₁ to A₁₀. A preparation time 41 is a production preparation time required to start the production process in a production line. Each of switching times 51 to 53 is a lot switching time required for switching lots. Therefore, in the production line, a total processing time tₜₒₜₐₗ required for all the production processes of the lots A₁ to A₁₀ is expressed by the following Formula (1).

$$\begin{matrix}[ Math . 1 ] & \\ {t}_{total} = \sum {t}_{{A}_{i}} + \sum f ( {A}_{i} , {A}_{i + 1} ) + g ( {A}_{0} ) & ( 1 )\end{matrix}$$

“t_{Ai}” is a processing time for producing each lot. “f(Aᵢ, Aᵢ₊₁)” is a lot switching time at the time of switching from “Aᵢ” to “Aᵢ₊₁”. “g(A₀)” is a production preparation time.

The production planning device 1 includes an acquisition unit 11, a distribution planning unit 13, an order planning unit 17, a storage unit 18, and an output unit 19. The acquisition unit 11 acquires the article list information L. The article list information L includes, for example, information regarding a plurality of types of articles. The information regarding the plurality of types of articles includes, for example, article names for specifying articles. The article names respectively correspond to different types of articles, for example. The production planning device 1 creates production plan data based on the article list information L acquired by the acquisition unit 11.

The acquisition unit 11 acquires information input from the inside or the outside of the production planning device 1. For example, the acquisition unit 11 acquires the article list information L from a storage region outside the production planning device 1 via an external network such as the Internet or an internal network. The acquisition unit 11 may acquire the article list information L from the storage unit 18. The acquisition unit 11 may acquire information directly input from a user as the article list information L.

The distribution planning unit 13 creates distribution plan data. The distribution plan data indicates a distribution pattern for distributing a plurality of types of articles included in the article list information L to a plurality of production lines. The distribution planning unit 13 creates distribution plan data based on entropy S. The entropy S is associated with loss information regarding loss of production process speed in each production line. The loss information includes, for example, the number of articles for every type of the articles to be distributed to each of the production lines. In other words, the distribution planning unit 13 creates distribution plan data based on the entropy S associated with the number of articles for every type to be distributed to each of the production lines.

For example, it is considered that the lot switching time increases and the loss of the production process speed also increases as the number of types of articles distributed to the production lines increases. Therefore, in replacement with thermodynamics, it is considered that the more types of articles distributed to the production lines, the higher the randomness and the larger the entropy. Thus, for example, the number of articles for every type to be distributed to each production line is made to correspond to the number of particles of each type in thermodynamics.

In thermodynamics, the entropy S is represented by Formula (2): S=k_{B}InW. “k_{B}” is a Boltzmann's constant. “W” is the degeneracy. “W” is represented by the following Formula (3). “nᵢ” is the number of particles of type i. “N” is the sum of nᵢ.

$$\begin{matrix}[ Math . 2 ] & \\ W = \frac{N !}{{n}_{1} ! {n}_{2} ! … {n}_{i} !} = \frac{N !}{\prod {n}_{i} !} & ( 3 )\end{matrix}$$

The distribution planning unit 13 calculates the entropy S through, for example, calculation of substituting the number of articles to be distributed to production lines into “N” in Formula (3) and substituting the number of articles of each type to be distributed to the production line into “nᵢ” in Formula (3). In this case, “k_{B}” may be 1.

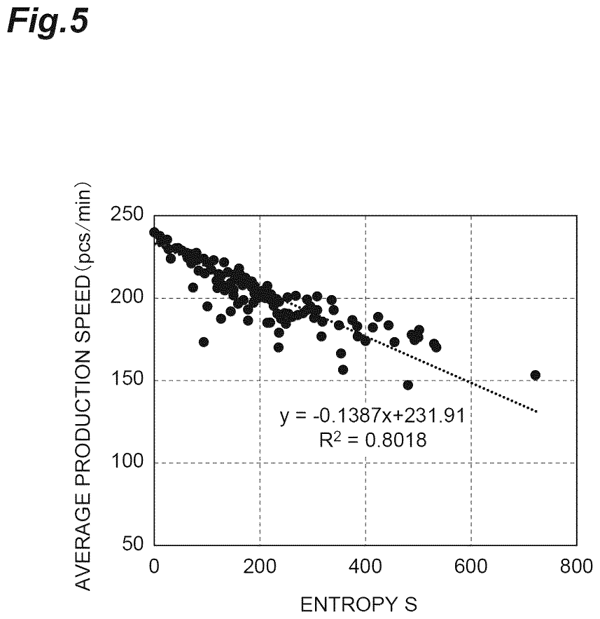

As illustrated in FIG. 5, the entropy S has a correlation with an average production speed of the articles distributed to the production lines. FIG. 5 is a correlation diagram between an average production speed calculated without using the entropy S and the entropy S. In this case, the R² value is 0.8. In the present specification, the “average production speed calculated without using entropy” is a production process speed calculated by simultaneously applying a genetic algorithm to a creation order of articles in a production line and a distribution pattern for distributing a plurality of types of articles to a plurality of production lines.

In the example described in the present embodiment, the distribution planning unit 13 creates distribution plan data based on enthalpy H and on the entropy S. The enthalpy H is associated with a total number of a plurality of types of articles to be distributed to the respective production lines. In thermodynamics, the enthalpy H is a sum of energy of particles. In a case where Gibbs energy of a system is denoted by “G”, a relationship between the Gibbs energy G, the enthalpy H, and the entropy S is expressed by Formula (4): G=H−TS. “T” is a coefficient. Formula (4) can be transformed into Formula (5): G/H=1−(TS/H).

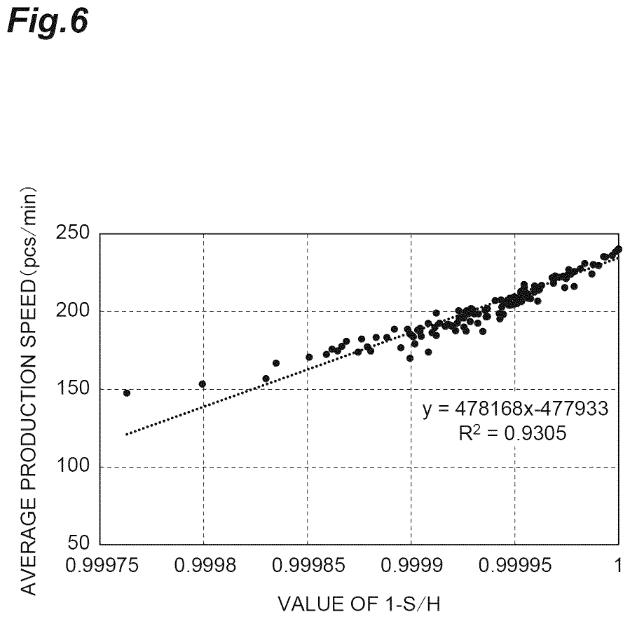

Formula (5) constituted by the enthalpy H and the entropy S corresponds to thermal efficiency in thermodynamics. As illustrated in FIG. 6, Formula (6): 1−(S/H) in which “T” in Formula (5) is 1 has a correlation with the average production speed calculated without using the entropy S. FIG. 6 is a correlation diagram of an average production speed calculated without using the entropy S, the entropy S, and the enthalpy H. FIG. 6 is a correlation diagram between the average production speed calculated without using the entropy S and 1−(S/H). In this case, the R² value is 0.93.

When the maximum processing speed vₘₐₓ in the production line is integrated on both sides of Formula (5), Formula (7): vₘₐₓ(G/H)=vₘₐₓ−vₘₐₓ(TS/H) is derived. The maximum processing speed corresponds to the maximum production speed (pcs/min) of articles in each production line. Formula (7) corresponds to the following Formula (8).

$$\begin{matrix}[ Math . 3 ] & \\ \overline{{v}_{pred}} = {v}_{ma x} - {v}_{loss \_ pred} & ( 8 )\end{matrix}$$

The left side of Formula (8) is a predicted processing speed. The predicted processing speed is a production process speed of articles distributed to the production line, and is an average production speed predicted through calculation using the entropy S and the enthalpy H. Hereinafter, the predicted processing speed will be simply referred to as “v_{pred}” while the bar is partially omitted. “v_{loss_pred}” is a predicted loss speed. The predicted loss speed is loss of production process speed in a production line, and is a value predicted through calculation using the entropy S and the enthalpy H.

In a case where the predicted processing time is “Time_{pred}”, Formula (9) is established in consideration of Formulas (7) and (8). The predicted processing time is a production process time of articles described to the production line.

$$\begin{matrix}[ Math . 4 ] & \\ {Time}_{pred} \approx \frac{{N}_{pcs}}{\overline{{v}_{pred}}} = \frac{H}{{ν}_{m ax} \frac{G}{H}} = \frac{H}{{ν}_{ma x} ( 1 - \frac{T S}{H} )} = \frac{{H}^{2}}{{ν}_{m ax} ( H - T S )} & ( 9 )\end{matrix}$$

The distribution planning unit 13 includes a time calculation unit 21 and a distribution calculation unit 22. The time calculation unit 21 calculates a predicted processing time of a plurality of types of articles distributed to each production line. The time calculation unit 21 calculates a predicted processing time based on the entropy S and the enthalpy H.

For example, the time calculation unit 21 calculates a predicted processing time so that Formula (9) is satisfied. For example, the time calculation unit 21 calculates a predicted processing time so that Formula (10): Time_{pred}=H/v_{pred} and Formula (11): v_{pred}=vₘₐₓ(G/H) are satisfied. In this case, in each of the plurality of production lines, the predicted processing time in each production line is “Time_{pred}”, the predicted processing speed of the plurality of types of articles distributed to each production line is “v_{pred}”, the maximum processing speed in each production line is “vₘₐₓ”, the enthalpy in each production line is “H”, and the Gibbs energy calculated from the entropy and the enthalpy in each production line is “G”.

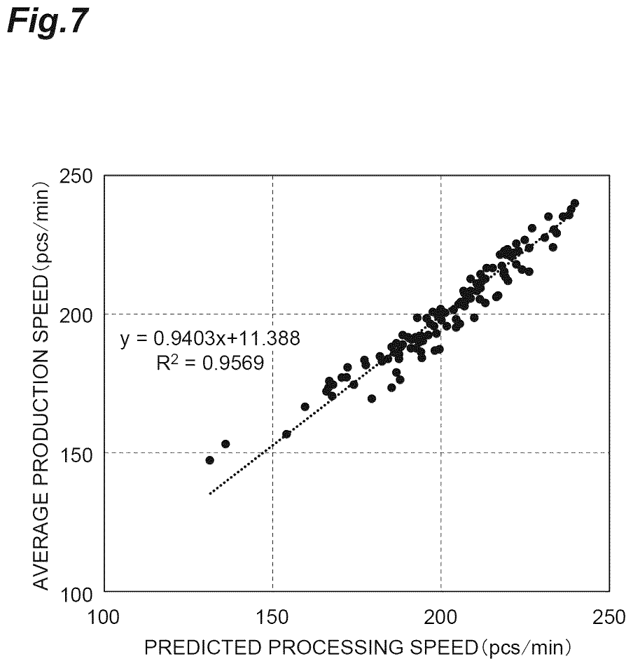

As illustrated in FIG. 7, a predicted processing speed has a correlation with an average production speed of articles distributed to production line. FIG. 7 is a correlation diagram between an average production speed calculated without using the entropy S and a predicted processing speed. In this case, the R² value is 0.93.

The distribution calculation unit 22 creates distribution plan data based on the predicted processing time calculated by the time calculation unit 21. The distribution calculation unit 22 calculates a distribution pattern for distributing a plurality of types of articles included in the article list information L to each of a plurality of production lines, based on the predicted processing time calculated by the time calculation unit 21. For example, the distribution calculation unit 22 calculates a sum and a variance of the predicted processing times for the plurality of production lines and, based on the calculation result, calculates a distribution pattern for distributing a plurality of types of articles included in the article list information L to the plurality of respective production lines.

The distribution calculation unit 22 calculates a sum Timeₜₒₜₐₗ of the predicted processing times of the plurality of production lines according to the following Formula (12). “M” is the number of production lines. For example, “M” is the number of machines to which articles are distributed. “Timeⁱ_{pred}” is a predicted processing time of an i-th production line.

$$\begin{matrix}[ Math . 5 ] & \\ {Time}_{total} = {\sum }_{i = 1}^{M} {Time}_{pred}^{i} & ( 12 )\end{matrix}$$

The distribution calculation unit 22 calculates a variance var of the predicted processing times of the plurality of production lines according to the following Formula (13). “Time_{pred_AVG}” is an average of the predicted processing time.

$$\begin{matrix}[ Math . 6 ] & \\ var = \frac{1}{M} {\sum }_{i = 1}^{M} {( {Time}_{pred}^{i} - {Time}_{pred \_ AVG} )}^{2} & ( 13 )\end{matrix}$$

The order planning unit 17 creates order plan data. The order plan data indicates a creation order of articles in the production line. The order planning unit 17 creates order plan data based on the distribution plan data calculated by the distribution planning unit 13. The order planning unit 17 calculates the creation order of the articles distributed to the production line by using a known method. For example, the order planning unit 17 calculates the creation order of the articles so that the production process time is shortened by using a genetic algorithm.

The storage unit 18 stores various types of information in advance, and stores information from various functional units. The storage unit 18 stores, for example, the information acquired in the acquisition unit 11, the distribution plan data created in the distribution planning unit 13, and the order plan data created in the order planning unit 17.

The output unit 19 outputs the production plan data. The output unit 19 outputs, for example, the distribution plan data created in the distribution planning unit 13 and the order plan data created in the order planning unit 17. The output unit 19 includes, for example, a display unit, and displays the production plan data. The output unit 19 may transmit the production plan data to the outside of the production planning device 1.

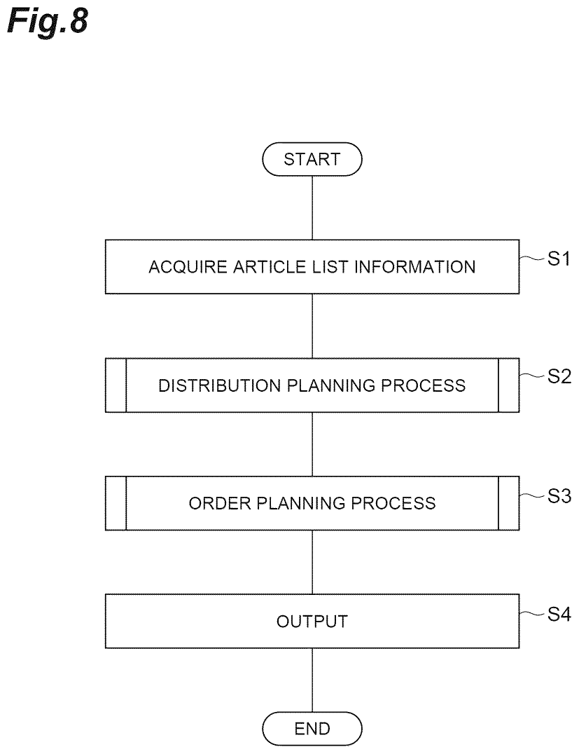

Next, an example of a production planning method in the present embodiment will be described with reference to FIG. 8. FIG. 8 is a flowchart illustrating a part of the production planning method.

First, the acquisition unit 11 acquires the article list information L (processing S1). Next, the distribution planning unit 13 executes distribution planning process (processing S2). In processing S2, the distribution planning unit 13 creates distribution plan data based on the article list information L acquired in processing S1. In processing S2, the distribution planning unit 13 creates distribution plan data for distributing a plurality of types of articles included in the article list information L to a plurality of production lines, based on entropy associated with loss information regarding loss of production process speed in each production line.

Next, the order planning unit 17 executes an order planning process (processing S3). In processing S3, the order planning unit 17 creates order plan data based on the distribution plan data calculated in processing S2. In other words, in processing S3, the order planning unit 17 calculates a creation order of the articles to be distributed to the production line, based on the distribution plan data.

Next, the output unit 19 outputs the production plan data (processing S4). The output unit 19 outputs, for example, the distribution plan data created in the distribution planning unit 13 and the order plan data created in the order planning unit 17.

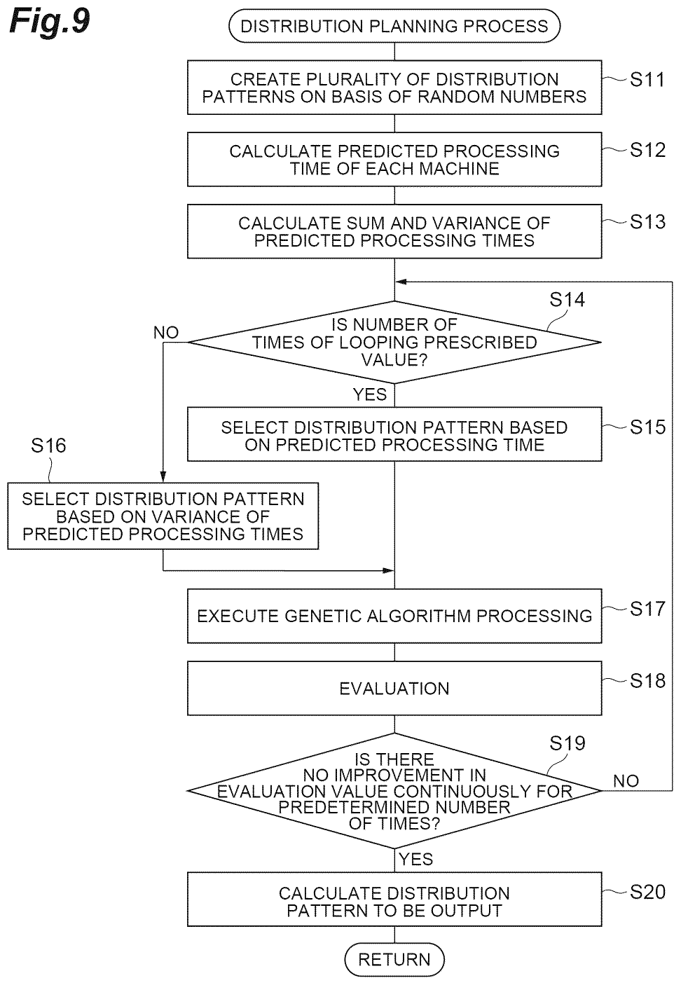

Next, an example of a distribution planning process in the present embodiment will be described with reference to FIG. 9. FIG. 9 is a flowchart illustrating a part of the distribution planning process.

First, the distribution calculation unit 22 derives a random number and creates a plurality of distribution patterns based on the random number (processing S11). For example, in processing S11, the distribution calculation unit 22 creates a plurality of distribution patterns in which the articles included in the article list information L acquired in processing S1 are randomly distributed to the machines of the production lines. In processing S11, the plurality of created distribution patterns are set as parent data. For example, each distribution pattern has information regarding a machine to which each article is distributed as a gene.

Next, the time calculation unit 21 calculates a predicted processing time of each machine (processing S12). For example, in processing S12, the time calculation unit 21 calculates the entropy S and the enthalpy H for each machine of the production line. The time calculation unit 21 calculates the predicted processing time based on the calculated entropy S and enthalpy H, and Formulas (4), (10), and (11). In processing S12, the time calculation unit 21 calculates a predicted processing time for each of all the production lines in the plurality of distribution patterns set as the parent data.

Next, the distribution calculation unit 22 calculates a total processing time and a variance (processing S13). In processing S13, the distribution calculation unit 22 calculates a sum of the predicted processing times on the basis of Formula (12) in each of the plurality of distribution patterns set as the parent data. For example, the distribution calculation unit 22 calculates the sum of the predicted processing times in all of the plurality of distribution patterns set as the parent data. In processing S13, the distribution calculation unit 22 calculates a variance of the predicted processing time on the basis of Formula (13) in each of the plurality of distribution patterns set as the parent data. For example, the distribution calculation unit 22 calculates the variance of the predicted processing times in all of the plurality of distribution patterns set as the parent data.

Next, the distribution calculation unit 22 determines whether or not the number of times of looping from processing S13 to processing S19 is a predetermined value (processing S13). The predetermined value is, for example, a number of 2 or greater. For example, in processing S13, the distribution calculation unit 22 acquires the number of times of looping from processing S13 to processing S19, and determines whether or not the acquired number of times of looping is a multiple of 3. In a case where it is determined that the number of times of looping is the predetermined value, the process proceeds to processing S14 (YES in processing S13). In a case where it is determined that the number of times of looping is not the predetermined value, the process proceeds to processing S15 (NO in processing S13).

In a case where it is determined that the number of times of looping is the predetermined value, the distribution calculation unit 22 calculates a sum of the predicted processing times (processing S14). When processing S14 is ended, the process proceeds to processing S16. For example, in processing S14, the distribution calculation unit 22 calculates a sum of the predicted processing times on the basis of Formula (12) in each of the plurality of distribution patterns set as the parent data. For example, the distribution calculation unit 22 calculates the sum of the predicted processing times in all of the plurality of distribution patterns set as the parent data.

In a case where it is determined that the number of times of looping is not the predetermined value, the distribution calculation unit 22 calculates a variance of the predicted processing times (processing S15). When processing S15 is ended, the process proceeds to processing S16. For example, in processing S15, the distribution calculation unit 22 calculates the variance of the predicted processing times on the basis of Formula (12) in each of the plurality of distribution patterns set as the parent data. For example, the distribution calculation unit 22 calculates the variance of the predicted processing times in all of the plurality of distribution patterns set as the parent data.

The distribution calculation unit 22 selects a plurality of distribution patterns based on the sum of the predicted processing times or the variance of the predicted processing times (processing S16). For example, in processing S16, the distribution calculation unit 22 selects distribution patterns of the top X % having a small sum of the predicted processing times in processing S14 from among the plurality of distribution patterns set as the parent data. For example, the distribution calculation unit 22 selects distribution patterns of the top X % having the small variance of the predicted processing times in processing S15 from among the plurality of distribution patterns set as the parent data. The top X % is, for example, the top 50%. The distribution calculation unit 22 updates the plurality of distribution patterns selected in processing S16 as the parent data.

Next, the distribution calculation unit 22 executes genetic algorithm processing (processing S17). For example, in processing S17, the distribution calculation unit 22 selects two distribution patterns from among a plurality of distribution patterns set as parent data, and creates, as child data, a distribution pattern that has taken over information regarding a common portion of genes of the selected two distribution patterns. In processing S17, the distribution calculation unit 22 selects two distribution patterns from among the plurality of distribution patterns set as the parent data by using, for example, a random number. In processing S17, the distribution calculation unit 22 replaces, for example, a gene not taken over from the parent data with information determined by using a random number while complying with machine constraint conditions. In processing S17, the distribution calculation unit 22 creates distribution patterns as the child data by the number of distribution patterns created in processing S11.

In processing S17, the distribution calculation unit 22 creates the child data to which mutation data is added with a prescribed probability. The distribution calculation unit 22 replaces the mutation data with part of information of the common portion of the distribution patterns selected from the parent data. For example, the distribution calculation unit 22 replaces the mutation data with information determined by using a random number while complying with constraint conditions with a probability of 1%.

Next, the distribution planning unit 13 performs evaluation (processing S18). For example, in processing S18, the time calculation unit 21 calculates a predicted processing time of each machine by using the child data created in processing S17 similarly to processing S12. In processing S18, the time calculation unit 21 calculates a predicted processing time for each of all the production lines in the plurality of distribution patterns set as the child data. In processing S18, the distribution calculation unit 22 calculates a sum of the predicted processing times in all of the plurality of distribution patterns set as the child data. For example, the distribution calculation unit 22 sets the sum of the predicted processing times calculated in processing S18 as an evaluation value.

Next, the distribution calculation unit 22 determines whether there is no improvement in the evaluation value continuously for a predetermined number of times (processing S19). For example, in a case where it is determined that there is no improvement in the evaluation value continuously for a predetermined number of times, the process proceeds to processing S20 (YES in processing S19). For example, in a case where it is not determined that there is no improvement in the evaluation value continuously for a predetermined number of times, the child data is set as parent data, and the process proceeds to processing S13 (NO in processing S19). For example, the predetermined number of times is ten times.

In a case where it is not determined that there is no improvement in the evaluation value continuously for the predetermined number of times, the distribution calculation unit 22 calculates a distribution pattern to be output (processing S20). The sum of the predicted processing times converges to a relatively stable value by repeating the loop. On the other hand, the variance of the predicted processing times vibrates. Thus, for example, the distribution calculation unit 22 calculates, as the distribution pattern to be output, a distribution pattern having the smallest variance of the predicted processing times in +5 generations of a generation having the smallest sum of the predicted processing times. As described above, a distribution pattern in which both the sum of the predicted processing times and the variance of the predicted processing times are reduced can be output.

Although an example of the production planning method has been described above, the order of each process and the number of times of looping are not limited thereto. For example, calculation of a sum of the predicted processing times and calculation of a variance of the predicted processing times may be performed after processing S13.

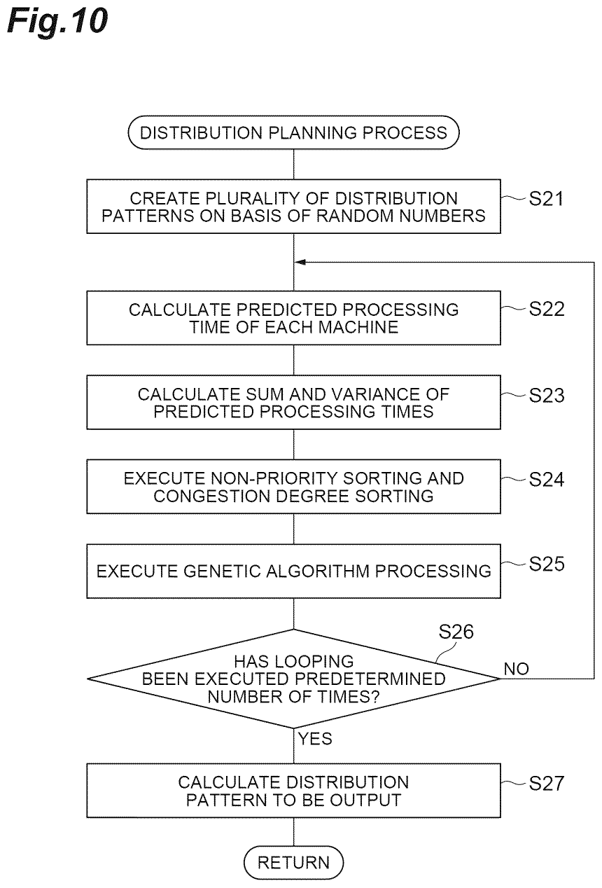

Next, an example of a production planning method in a modification example of the present embodiment will be described with reference to FIG. 10. The present modification example is different from the above-described embodiment in that NSGA2 is used. Hereinafter, differences between the above-described embodiment and the modification example will be mainly described. FIG. 10 is a flowchart illustrating a part of the production planning method.

First, the distribution calculation unit 22 derives a random number and creates a plurality of distribution patterns based on the random number (processing S21). For example, in processing S21, the distribution calculation unit 22 creates a plurality of distribution patterns in which articles included in the article list information L acquired in processing S1 are randomly distributed to the machines of the production lines. In processing S21, the plurality of created distribution patterns are set as parent data. For example, each distribution pattern has information regarding a machine to which each article is distributed as a gene.

Next, the time calculation unit 21 calculates a predicted processing time of each machine (processing S22). For example, in processing S22, the time calculation unit 21 calculates the entropy S and the enthalpy H for each machine of the production line. The time calculation unit 21 calculates the predicted processing time based on the calculated entropy S and enthalpy H, and Formulas (4), (10), and (11). In processing S22, the time calculation unit 21 calculates the predicted processing time for each of all the production lines in the plurality of distribution patterns set as the parent data.

Next, the distribution calculation unit 22 calculates a sum and a variance of the predicted processing times (processing S23). In processing S23, the distribution calculation unit 22 calculates the sum of the predicted processing times based on Formula (12) in each of the plurality of distribution patterns set as the parent data. For example, the distribution calculation unit 22 calculates the sum of the predicted processing times in all of the plurality of distribution patterns set as the parent data. In processing S23, the distribution calculation unit 22 calculates the variance of the predicted processing times based on Formula (13) in each of the plurality of distribution patterns set as the parent data. For example, the distribution calculation unit 22 calculates the variance of the predicted processing times in all of the plurality of distribution patterns set as the parent data.

Next, the distribution calculation unit 22 executes non-priority sorting and congestion degree sorting (processing S24). For example, the distribution calculation unit 22 executes non-priority sorting with the sum of the predicted processing times and the variance of the predicted processing times as objective variables. By executing the non-priority sorting, the distribution calculation unit 22 selects the top 50% in which the two objective variables are combined from among the plurality of distribution patterns set as the parent data. The distribution calculation unit 22 updates the plurality of distribution patterns selected in processing S24 as the parent data. For example, the distribution calculation unit 22 executes congestion degree sorting in an objective variable space of the sum of the predicted processing times and the variance of the predicted processing times.

Next, the distribution calculation unit 22 executes genetic algorithm processing (processing S25). For example, the distribution calculation unit 22 selects two distribution patterns with a low congestion degree by using random numbers, and creates a distribution pattern that takes over information of a common portion of genes of the selected two distribution patterns as child data. In processing S25, the distribution calculation unit 22 replaces, for example, a gene not taken over from the parent data with information determined by using a random number while complying with machine constraint conditions. In processing S25, the distribution calculation unit 22 creates distribution patterns as the child data by the number of distribution patterns created in processing S21.

In processing S25, the distribution calculation unit 22 creates the child data to which mutation data is added with a prescribed probability. The distribution calculation unit 22 replaces the mutation data with part of information of the common portion of the distribution patterns selected from the parent data. For example, the distribution calculation unit 22 replaces the mutation data with information determined by using a random number while complying with constraint conditions with a probability of 1%.

Next, the distribution calculation unit 22 determines whether or not looping has been executed a predetermined number of times (processing S26). For example, in a case where it is determined that the looping has been executed a predetermined number of times, the process proceeds to processing S27 (YES in processing S26). For example, in a case where it is determined that the looping has not been executed a predetermined number of times, the process proceeds to processing S22 (NO in processing S26). The predetermined number of times is, for example, a value set in advance.

Next, the distribution calculation unit 22 calculates a distribution pattern (processing S27). For example, the distribution calculation unit 22 calculates, as a distribution pattern to be output, a distribution pattern corresponding to a point closest to the origin by the Eugrid distance or a distribution pattern having the smallest total predicted processing time among distribution patterns with a prescribed variance or less. As described above, a distribution pattern in which both the sum of the predicted processing times and the variance of the predicted processing times are reduced can be output. Although an example of the production planning method has been described above, the order of each process and the number of times of looping are not limited thereto.

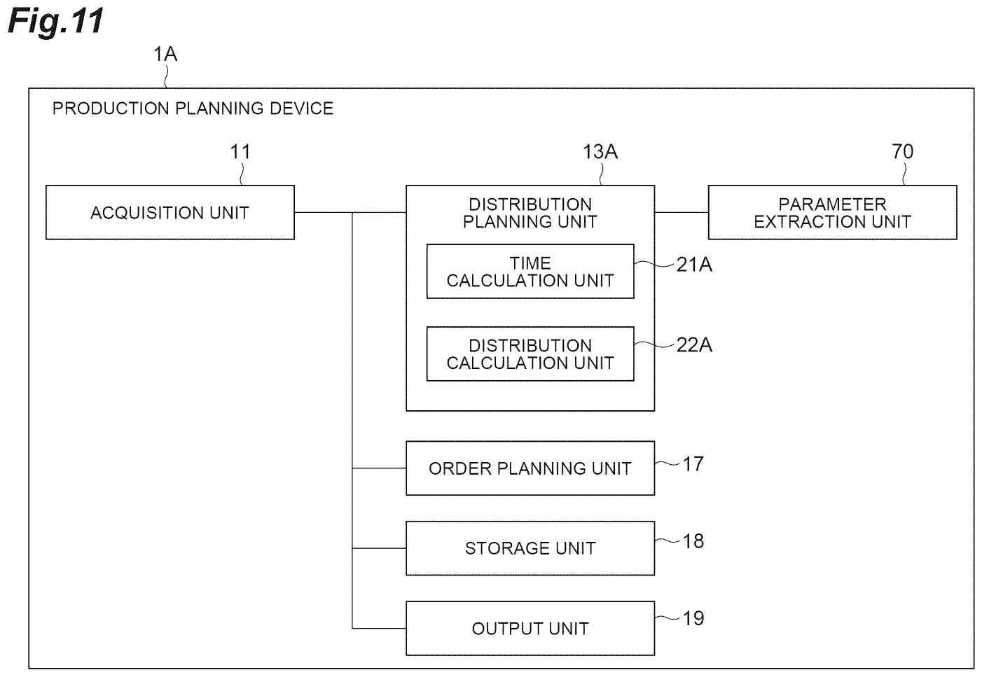

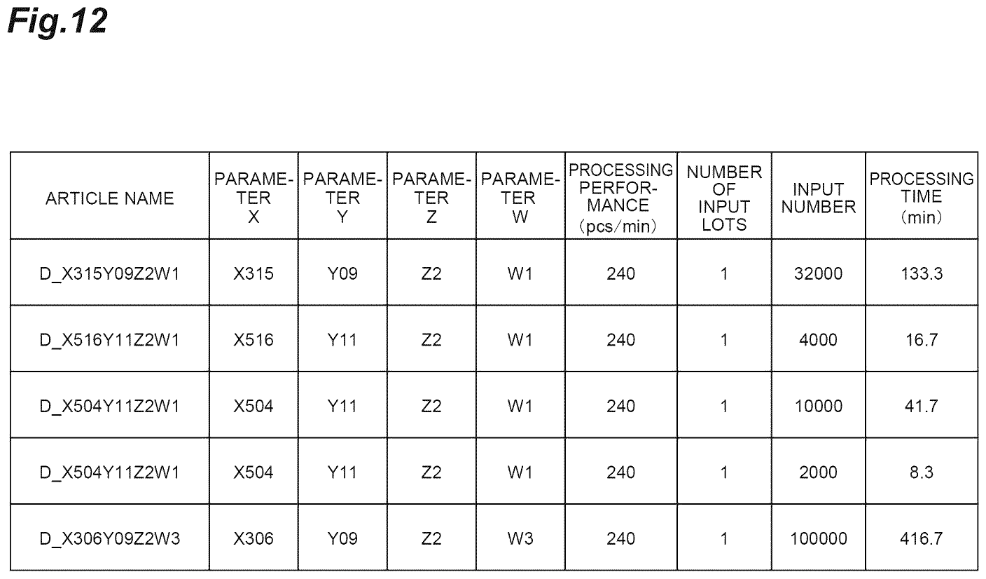

Next, a production planning device according to a modification example of the present embodiment will be described with reference to FIGS. 11 to 14. FIG. 11 is a block diagram of the production planning device. FIG. 12 is a table illustrating parameters of an article. The present modification example is generally similar to or the same as the above-described embodiment. The present modification example is different from the above-described embodiment in that a distribution planning unit 13A is provided instead of the distribution planning unit 13 and a parameter extraction unit 70 is provided. Hereinafter, differences between the above-described embodiment and the modification example will be mainly described.

The article list information L acquired by the acquisition unit 11 of a production planning device 1A includes, for example, information regarding a plurality of types of articles. As illustrated in FIG. 12, the article list information L acquired by the acquisition unit 11 of the production planning device 1A includes parameter information indicating at least one value of each of parameters. The parameters are a plurality of types of parameters respectively specifying a plurality of types of articles. The parameter information includes, for example, an article name for specifying an article, a parameter X, a parameter Y, a parameter Z, and a parameter W. The production planning device 1A creates production plan data based on the article list information L acquired by the acquisition unit 11.

The distribution planning unit 13A of the production planning device 1A creates distribution plan data based on the entropy S. The entropy S is associated with loss information regarding loss of production process speed in each production line. The loss information includes, for example, the number of the at least one value for every type of the at least one value of each of the parameters. In other words, the distribution planning unit 13A creates the distribution plan data based on the entropy S associated with the number of the at least one value for every type of the at least one value of each of the plurality of parameters included in the plurality of types of parameters.

The distribution planning unit 13A of the production planning device 1A calculates the entropy S through, for example, calculation of substituting the number of articles to be distributed to the production lines into “N” in Formula (3) and substituting the number of values of each type of each parameter of the articles to be distributed to the production line into “n;” in Formula (3). For example, in the table illustrated in FIG. 12, the entropy S associated with the number of values of each type of the article name is In(5!/1!1!2!1!). The entropy S associated with the number of values of each type of the parameter X is In(5!/1!1!2!1!). The entropy S associated with the number of values of each type of the parameter Y is In(5!/2!3!). The entropy S associated with the number of values of each type of the parameter Z is In(5!/5!). The entropy S associated with the number of values of each type of the parameter W is In(5!/4!1!).

In the present modification example, the distribution planning unit 13A creates distribution plan data based on the enthalpy H and the entropy S. The enthalpy H is associated with a total number of a plurality of types of articles to be distributed to the respective production lines. In thermodynamics, the enthalpy H is a sum of energy of particles. When entropy of each parameter is Si for a plurality of types of parameters, a relationship between the enthalpy H and the entropy S is expressed by Formula (21): G/H=1−(1/H)ΣTᵢSᵢ. “i” indicates a difference in parameter type.

The production planning device 1A further includes the parameter extraction unit 70 in addition to the configuration of the production planning device 1. The parameter extraction unit 70 extracts a plurality of parameters from a plurality of types of parameters on the basis of correlation information among the plurality of types of parameters.

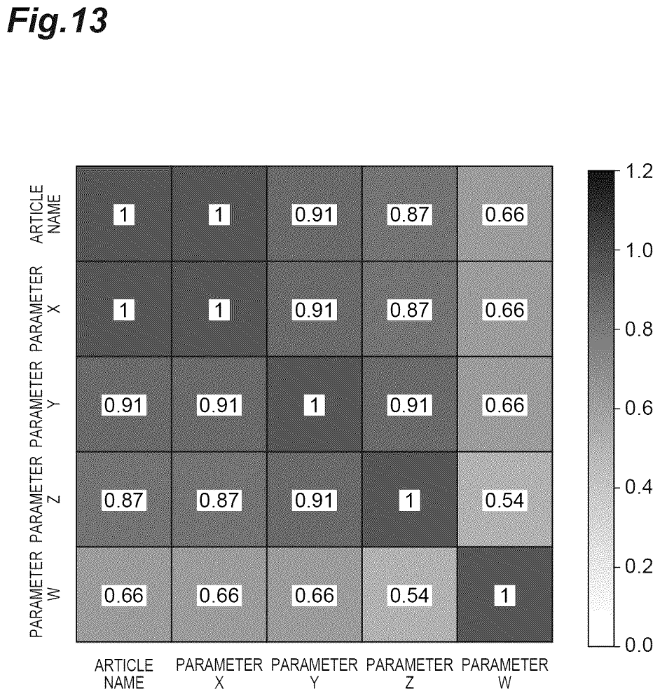

For example, the parameter extraction unit 70 extracts a parameter included in a second combination having a correlation coefficient lower than the correlation coefficient of a first combination among the plurality of types of parameters. FIG. 13 is a diagram illustrating a correlation of parameters of an article. FIG. 13 illustrates a correlation coefficient between parameters. In the example illustrated in FIG. 13, the correlation coefficient between the article name, the parameter X, the parameter Y, and the parameter Z is 0.87 to 1. The parameter W has a correlation coefficient of 0.66 or less with respect to the other parameters. In this case, for example, a combination of the article name, the parameter X, the parameter Y, and the parameter Z corresponds to the first combination, and a combination of the parameter W and other parameters corresponds to the second combination. For example, the parameter extraction unit 70 extracts the parameter X and the parameter Z included in the second combination.

In this case, the following Formula (22) is derived by substituting Formula (21) into Formula (9).

$$\begin{matrix}[ Math . 7 ] & \\ {Time}_{pred} \approx \frac{{N}_{p c s}}{\overline{{v}_{p r e d}}} = \frac{H}{{ν}_{m ax} \frac{G}{H}} = \frac{H}{{ν}_{m ax} ( 1 - \frac{1}{H} \sum {T}_{i} {S}_{i} )} = \frac{{H}^{2}}{{ν}_{m ax} ( H - \sum {T}_{i} {S}_{i} )} & ( 22 )\end{matrix}$$

The distribution planning unit 13A creates distribution plan data based on the entropy Sᵢ associated with the number of values of each type of each parameter extracted by the parameter extraction unit 70. For example, the time calculation unit 21A calculates a predicted processing time so that Formula (22) is satisfied. The distribution calculation unit 22A calculates a sum Timeₜₒₜₐₗ of the predicted processing times of the plurality of production lines according to the Formula (12) above. The distribution calculation unit 22A calculates the variance var of the predicted processing times of the plurality of production lines according to the Formula (13) above.

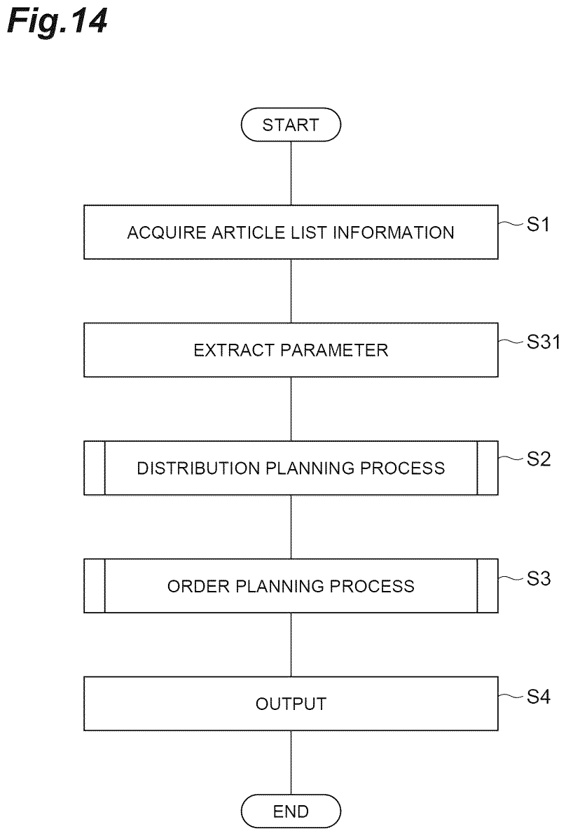

Next, a production planning method in the present modification example will be described with reference to FIG. 14. FIG. 14 is a flowchart illustrating a part of the production planning method. The production planning method illustrated in FIG. 14 is different from the production planning method illustrated in FIG. 8 in that a distribution planning unit 13A is used instead of the distribution planning unit 13 and that a parameter extraction process of the parameter extraction unit 70 is included. Hereinafter, differences from the production planning method illustrated in FIG. 8 will be mainly described.

First, the acquisition unit 11 acquires the article list information L (processing S1). Next, the parameter extraction unit 70 extracts a plurality of parameters from the plurality of types of parameters on the basis of the correlation information between the plurality of types of parameters included in the article list information L (processing S31). The parameter extraction unit 70 extracts a parameter included in the second combination having a correlation coefficient lower than the correlation coefficient of the first combination among the plurality of types of parameters.

Next, the distribution planning unit 13A executes a distribution planning process (processing S2). In processing S2, the distribution planning unit 13A creates distribution plan data based on the entropy Sᵢ associated with the number of values of each type of each parameter extracted by the parameter extraction unit 70.

Next, the order planning unit 17 executes an order planning process (processing S3). Next, the output unit 19 outputs the production plan data (processing S4). The output unit 19 outputs, for example, the distribution plan data created in the distribution planning unit 13A and the order plan data created in the order planning unit 17.

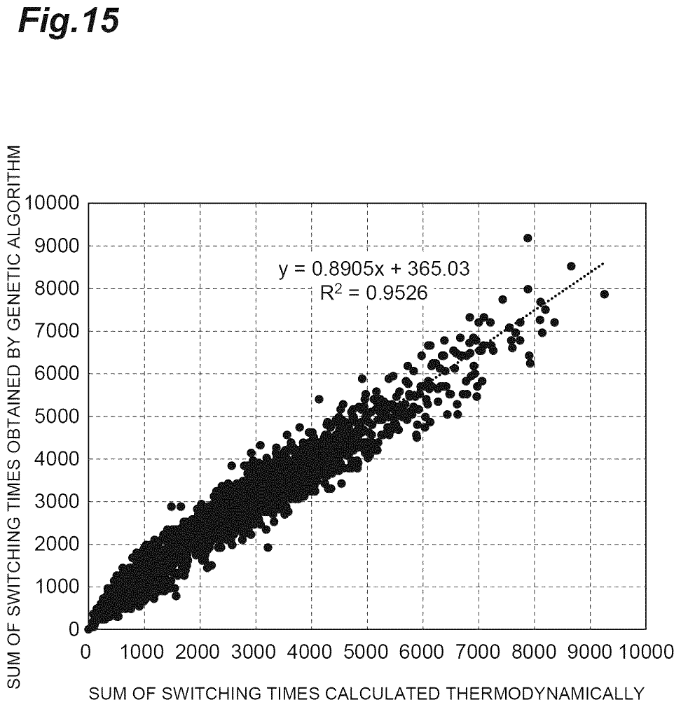

Next, a production planning device in a modification example of the present embodiment will be described with reference to FIG. 15. The present modification example is generally similar to or the same as the above-described embodiment. The present modification example is different from the above-described embodiment in that the time calculation unit 21A performs different process from that of the above-described time calculation unit 21A. Hereinafter, differences between the above-described embodiment and the modification example will be mainly described.

In the present embodiment, the distribution planning unit 13A creates distribution plan data based on the entropy S. The entropy S is associated with loss information regarding loss of production process speed in each of the production lines. In the present embodiment, the loss information includes, for example, switching times of articles distributed for each of the production lines, that is, a lot switching time in each of the production lines. In other words, the loss information includes, for example, a switching time depending upon the number of values for every type of values of each of the parameters. In other words, the distribution planning unit 13A creates a distribution planning data based on the entropy S associated with the lot switching time in each of the production lines.

At a predicted processing time in each of the plurality of production lines, Formula (23): Time_{pred}=Time_{ideal}+Timeₗₒₛₛ is satisfied. “Time_{pred}” denotes a predicted processing time in each of production lines. The predicted processing time is a production process time of articles distributed to the production line. “Time_{ideal}” denotes an ideal processing time in each of the production lines. “Timeₗₒₛₛ” denotes a loss time in each of the production lines. The loss time corresponds to for example, to the switching time of the articles distributed in each of production lines, that is, the lot switching time in each of production lines.

In this case, “Time_{ideal}” is represented by Formula (24): Time_{ideal}=Σ(Ni/vi). “Nᵢ” denotes the total number of the i-th type of article among the plurality of types of articles to be distributed to the respective production lines. “vᵢ” denotes a predicted processing speed of an i-th type of article among the plurality of types of articles distributed to the respective production lines.

“Timeₗₒₛₛ” is represented by Formula (25): Timeₗₒₛₛ=ΣXⱼSⱼ using entropy S. “Xⱼ” denotes a coefficient of the j-th parameter among a plurality of types of parameters distributed to each of the production lines. “Sⱼ” denotes ane entropy for the j-th parameter among a plurality of types of parameters distributed to each of the production lines.

In this modification, the time calculation unit 21A thermodynamically calculates the predicted processing time so as to satisfy Formulas (23), (24), and (25). The predicted processing time calculated thermodynamically in this manner is correlated with the predicted processing time obtained by the genetic algorithm. FIG. 15 is a correlation diagram between a sum of switching times obtained by genetic algorithms and a sum of switching times calculated thermodynamically. The R² value is 0.9526. Thus, there is a strong correlation between the sum of switching times obtained by genetic algorithms and the sum of switching times calculated thermodynamically.

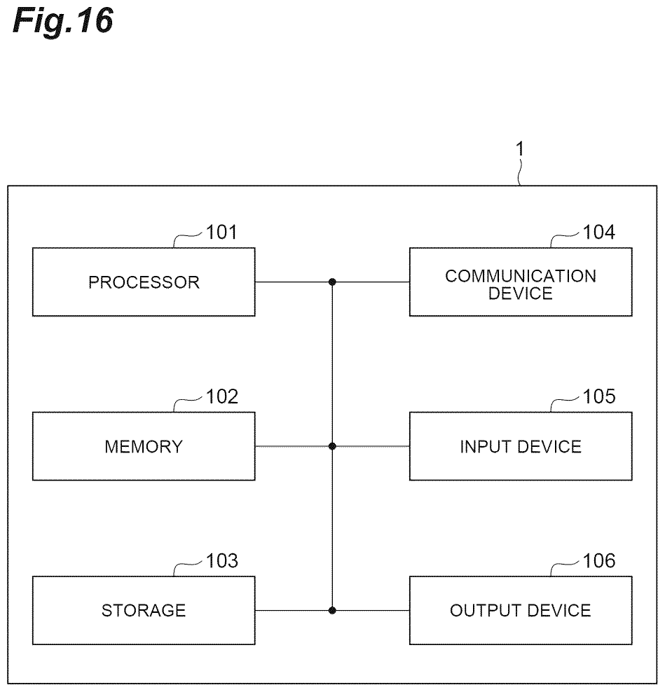

Next, a hardware configuration of the production planning devices 1 and 1A will be described with reference to FIG. 16. FIG. 16 is a diagram illustrating an example of a hardware configuration of the production planning device 1. The production planning device 1A also has a hardware configuration similar to that of the production planning device 1.

The production planning devices 1 and 1A include a processor 101, a main storage device 102, an auxiliary storage device 103, a communication device 104, an input device 105, and an output device 106. The production planning devices 1 and 1A include one or a plurality of computers configured by these pieces of hardware and software such as a program. Each of the acquisition unit 11, the distribution planning units 13 and 13A, the order planning unit 17, the storage unit 18, the output unit 19, and the parameter extraction unit 70 may be configured by one computer or may be configured by a plurality of computers. The production planning devices 1 and 1A are implemented in cooperation with hardware.

In a case where the production planning device 1 or 1A includes a plurality of computers, these computers may be locally connected or may be connected via a communication network such as the Internet or an intranet. With this connection, one production planning device 1 or 1A is logically constructed.

The processor 101 executes an operating system, an application program, and the like. The main storage device 102 includes a read only memory (ROM) and a random access memory (RAM). For example, at least some of the various functional units of the production planning device 1 can be realized by the processor 101 and the main storage device 102. For example, at least some of the acquisition unit 11, the distribution planning units 13 and 13A, the order planning unit 17, the storage unit 18, the output unit 19, and the parameter extraction unit 70 are realized by the processor 101 and the main storage device 102.

The auxiliary storage device 103 is a storage medium including a hard disk, a flash memory, and the like. The auxiliary storage device 103 generally stores a larger amount of data than the main storage device 102. For example, at least a part of the storage unit 18 is realized by the auxiliary storage device 103.

The communication device 104 includes a network card or a wireless communication module. For example, at least a part of the acquisition unit 11 and the output unit 19 is realized by the communication device 104. The input device 105 includes a keyboard, a mouse, a touch panel, and the like. For example, at least a part of the acquisition unit 11 is realized by the input device 105. The output device 106 includes a display, a printer, and the like. For example, at least a part of the output unit 19 is realized by the output device 106. For example, the output device 106 includes a display device.

The auxiliary storage device 103 stores a program and data necessary for processes in advance. The program causes a computer to execute each functional element of the production planning device 1 or 1A. The program causes the computer to execute, for example, the above-described processing S1 to processing S31. This program may be provided after being recorded on a tangible recording medium such as a CD-ROM, a DVD-ROM, or a semiconductor memory. The program may be provided as a data signal via a communication network.

Next, functions and effects of the production planning devices 1 and 1A, the production planning method, and the program in the present embodiment or the modification examples will be described.

In the production planning device 1, the distribution planning unit 13 creates distribution plan data based on the entropy S. The entropy S is associated with loss information regarding loss of production process speed in each production line. As described above, the entropy S is associated with loss information regarding loss of production process speed, and the distribution plan data is created based on the entropy S. As illustrated in FIG. 5, the entropy S has a correlation with an average production speed of articles distributed to a production line. Therefore, when the distribution plan data is created based on the entropy S, the distribution plan data in which the production throughput is reduced while the calculation amount is curbed is created. Therefore, even in a case where a plurality of types of articles are created in a plurality of production lines, a production plan that can reduce the production throughput can be easily executed. The same applies to the production planning device 1A.

The loss information may include the number of articles of each type to be distributed to each production line. The entropy S may be associated with the number of articles of each type to be distributed to each of the plurality of production lines. In this case, a correlation between the entropy S and an average production speed of the articles distributed to the production line is more reliably ensured. Therefore, distribution plan data in which the production throughput is easily and reliably reduced is created.

The distribution planning unit 13 may create distribution plan data based on the enthalpy H and the entropy S with which a total number of a plurality of types of articles to be distributed to the respective production lines is associated. As illustrated in FIG. 6, “1−(S/H)” consisting of the enthalpy H and the entropy S has a correlation with an average production speed calculated without using entropy. This correlation is higher than when the enthalpy H is not used. Therefore, distribution plan data in which the production throughput is more easily and reliability reduced is created.

The distribution planning unit 13 may include the time calculation unit 21 and the distribution calculation unit 22. The time calculation unit 21 calculates a predicted processing time of a plurality of types of articles distributed to each production line. The distribution calculation unit 22 calculates a distribution pattern for distributing a plurality of types of articles included in the article list information L to a plurality of respective production lines, based on the predicted processing time calculated by the time calculation unit 21. The time calculation unit 21 may calculate the predicted processing time based on the entropy S and the enthalpy H. In this case, distribution plan data in which the production throughput is more easily and reliably reduced is created.

The distribution calculation unit 22 may calculate a sum and a variance of the predicted processing times for the respective production lines and, based on the calculation result, may calculate a distribution pattern for distributing a plurality of types of articles included in the article list information L to the respective production lines. In this case, distribution plan data in which the production throughput is more easily and reliably reduced is created.

The time calculation unit 21 may calculate the predicted processing time so that Time_{pred}=H/v_{pred} and v_{pred}=vₘₐₓ(G/H) are satisfied. In this case, the predicted processing time in each of the plurality of production lines may be “Time_{pred}”. A predicted processing speed of the plurality of types of articles distributed to each production line may be “v_{pred}”. The maximum processing speed in each production line may be “vₘₐₓ”. The enthalpy in each production line may be “H”. Gibbs energy calculated from the entropy and the enthalpy in each production line may be denoted by “G”. In this case, the predicted processing time is more easily calculated.

The time calculation unit 21 may calculate the predicted processing time such that Time_{pred}=Time_{ideal}+Timeₗₒₛₛ, Time_{ideal}=2(Nᵢ/vᵢ), and Timeₗₒₛₛ=ΣXⱼSⱼ are satisfied. In this case, the predicted processing times in each of the production lines may be denoted by “Time_{pred}”. An ideal processing time in each of the production lines may be dented by “Time_{ideal}”. A loss time in each of the production lines may be denoted by“Timeₗₒₛₛ”. A total number of an i-th type of article among the plurality of types of articles to be distributed to the respective production lines may be denoted by “Nᵢ”. A predicted processing speed of an i-th type of article among the plurality of types of articles to be distributed to the respective production lines may be denoted by “vᵢ”. A coefficient of j-th parameter among a plurality of types of parameters specifying each of the plurality of types of articles to be distributed to the respective production lines may be denoted by “Xⱼ”. The entropy corresponding to a j-th parameter among the plurality of types of parameters may be denoted by “Sⱼ”, In this case, the predicted processing time is more easily calculated.

The article list information L may include parameter information indicating a value of each parameter for a plurality of types of parameters respectively specifying a plurality of types of articles. The loss information may include the number of values of each type of each of the parameters. The distribution planning unit 13A creates distribution plan data based on entropy associated with the number of values of each type for each of a plurality of parameters included in a plurality of types of parameters. In this case, distribution plan data in which the production throughput is more easily and reliably reduced is created.

The production planning device 1A further includes the parameter extraction unit 70. The parameter extraction unit 70 extracts a plurality of parameters from a plurality of types of parameters, based on correlation information among the plurality of types of parameters. The distribution planning unit 13A may create distribution plan data based on entropy associated with the number of values of each type of each parameter extracted by the parameter extraction unit. In this case, less needed parameters can be eliminated to improve robustness. Therefore, distribution plan data capable of reducing the production throughput with higher accuracy is created.

The parameter extraction unit 70 may extract a parameter included in the second combination having a correlation coefficient lower than the correlation coefficient of the first combination among the plurality of types of parameters. In this case, for the parameter based on the correlation coefficient, a parameter with a low necessity may be excluded. When the number of parameters is reduced, robustness may be improved. Therefore, distribution plan data capable of reducing the production throughput with higher accuracy is created.

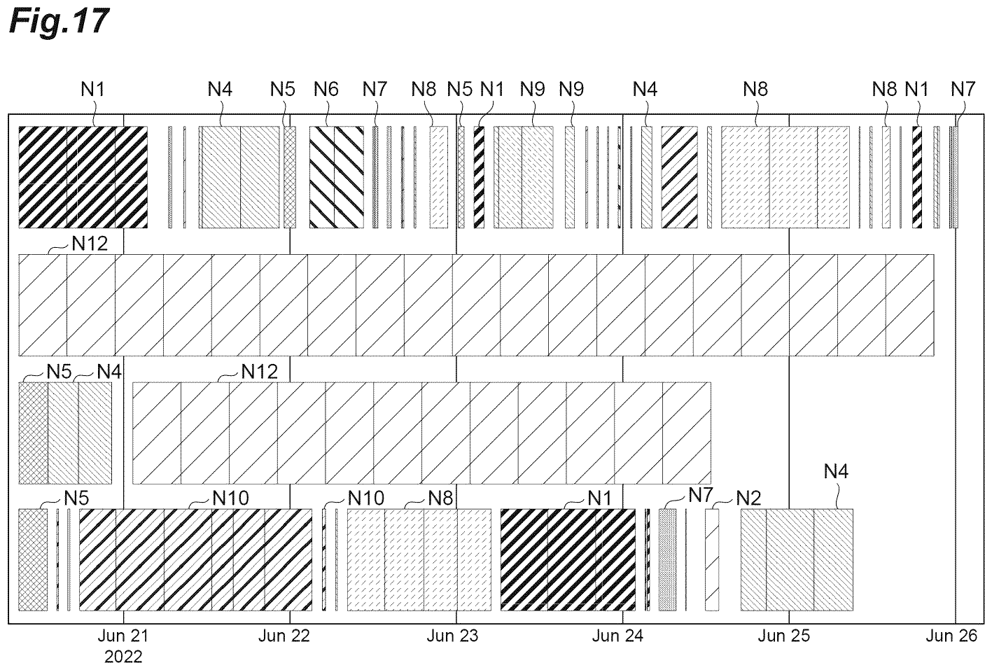

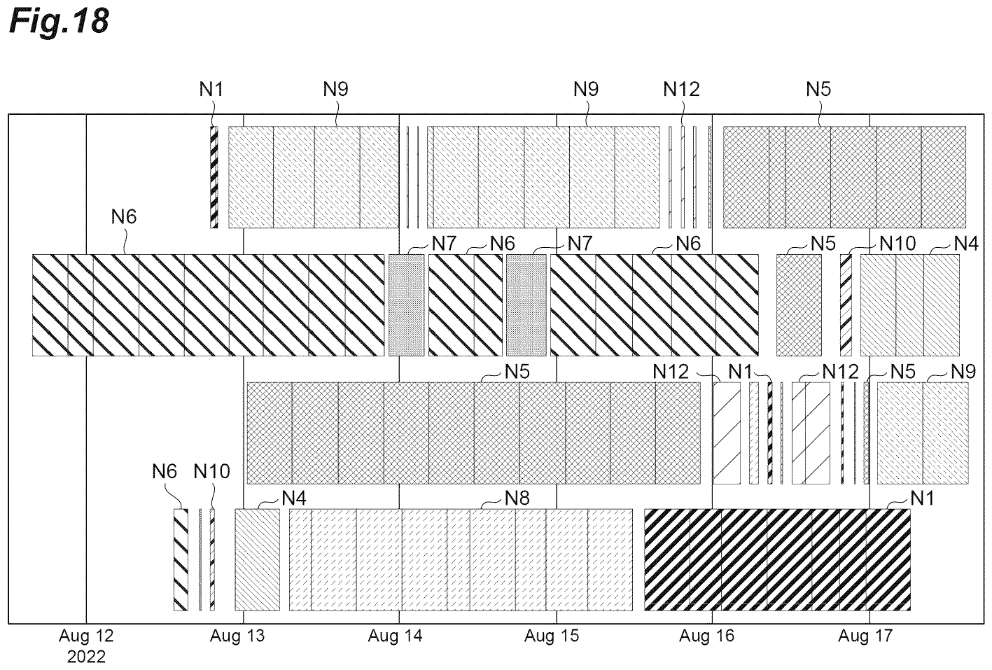

Next, an example of verification of the production planning device according to the present embodiment will be described with reference to FIGS. 17 to 20. FIG. 17 is a gantry chart of a plurality of production lines of production plan data in a comparative example. FIG. 18 is a gantry chart of a plurality of production lines of production plan data in the example described in the present embodiment. In the comparative example, a plurality of types of articles are distributed to production lines according to human's rule of thumb, and production plan data is created by using a genetic algorithm for each production line. In FIGS. 17 and 18, production process times of different types of articles N1 to N12 are illustrated. Identical symbols denote identical types of articles.

In a production line that produces the same type of article, it is considered that the lot switching time in Formula (1) is reduced. On the other hand, it is considered that the lot switching time increases as the number of types of articles distributed to the production lines increases. In the comparative example, the number of types of articles to be distributed significantly varies among production lines. In the comparative example, the end time of the production also significantly deviates. In contrast, in the production plan data in the example described in the present embodiment, it has been confirmed that the production process time is shortened as compared with the comparative example, and the deviation in the end time of the production is also reduced.

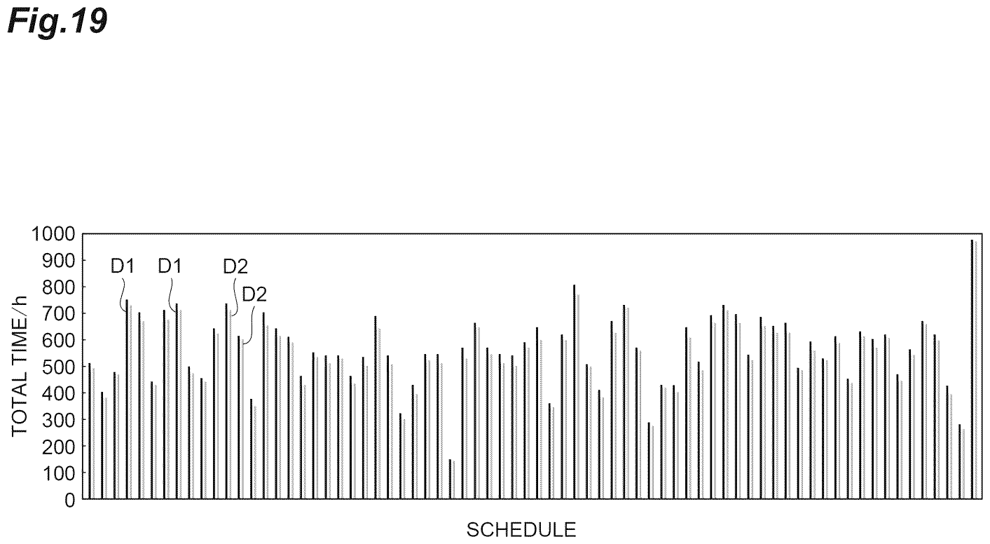

FIG. 19 is a graph for comparing a total predicted processing time between the example described in the present embodiment and the comparative example. In FIG. 19, data D1 indicates the comparative example, and data D2 indicates the example in the present embodiment. In FIG. 19, in the data D1, the entropy S is not used, and the genetic algorithm is simultaneously applied to the order of article creation in the production line and the distribution pattern for distributing a plurality of types of articles to a plurality of production lines. In the data D2, the distribution plan data is created in the production planning device 1A, and the articles are distributed based on the created distribution plan data, and then the creation order is created by the genetic algorithm. In this case, it has been confirmed that the sum of the predicted processing times of the data D2 is shorter than the sum of the predicted processing times of the data D1.

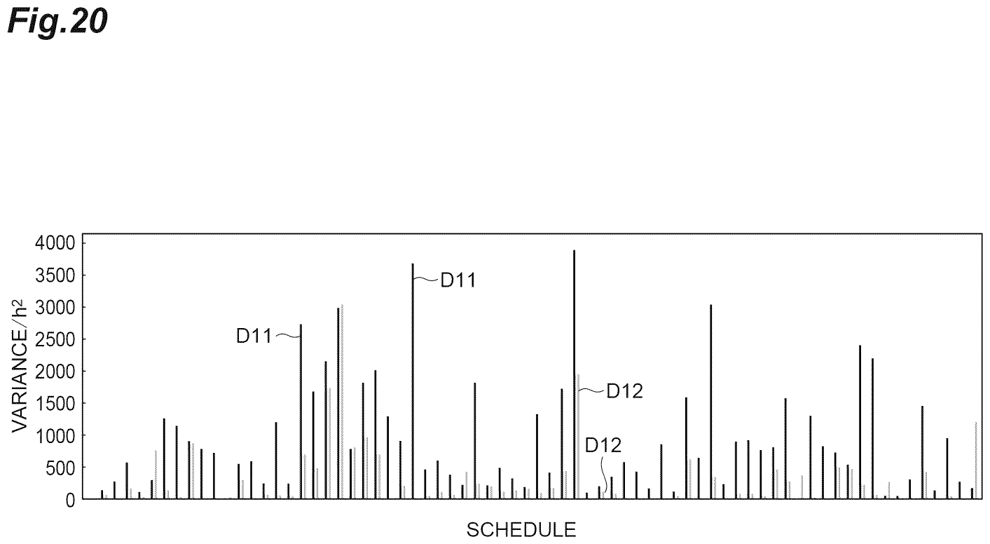

FIG. 20 is a graph for comparing a variance of the predicted processing time between the example described in the present embodiment and the comparative example. In FIG. 20, data D11 indicates the comparative example, and data D12 indicates the example in the present embodiment. In FIG. 20, in the data D11, the entropy S is not used, and the genetic algorithm is simultaneously applied to the order of article creation in the production line and the distribution pattern for distributing a plurality of types of articles to a plurality of production lines. In the data D12, the distribution plan data is created in the production planning device 1A, and the articles are distributed based on the created distribution plan data, and then the creation order is created by the genetic algorithm. In this case, it has been confirmed that the variance of the predicted processing times of the data D12 is smaller than the variance of the predicted processing times of the data D11.

Although the embodiments and modification examples of the present invention have been described above, the present invention is not necessarily limited to the above-described embodiments and modification examples, and various modification examples can be made without departing from the gist thereof.

For example, in the example described in the present embodiment, the configuration including both the distribution planning units 13 and 13A and the order planning unit 17 and executing both the distribution planning process and the order planning process has been described. However, only the distribution planning units 13 and 13A may be included without including the order planning unit 17. In this case, only the distribution plan data may be output as the production plan data.

In the example described in the present embodiment, the configuration in which the predicted processing time is calculated based on both the entropy and the enthalpy has been described. However, the production plan data may be created without calculating the predicted processing time. The production plan data may be created by using only entropy without using enthalpy.

What is claimed is:

1. A production planning device comprising:
an acquisition unit configured to acquire article list information including information regarding a plurality of types of articles; and
a distribution planning unit configured to create distribution plan data for distributing the plurality of types of articles included in the article list information to a plurality of production lines, wherein
the distribution planning unit creates the distribution plan data based on entropy associated with loss information regarding loss of production process speed in each of the production lines.

2. The production planning device according to claim 1, wherein
the loss information includes the number of the articles of each type to be distributed to each of the production lines, and
the entropy is associated with the number of the articles of each type to be distributed to each of the production lines.

3. The production planning device according to claim 1, wherein the distribution planning unit creates the distribution plan data based on an enthalpy associated with a total number of the plurality of types of articles to be distributed to the respective production lines and on the entropy.

4. The production planning device according to claim 3, wherein
the distribution planning unit includes a time calculation unit configured to calculate a predicted processing time of the plurality of types of articles distributed to each of the production lines, and a distribution calculation unit configured to calculate a distribution pattern for distributing the plurality of types of articles included in the article list information to the plurality of respective production lines, based on the predicted processing time calculated by the time calculation unit, and
the time calculation unit calculates the predicted processing time based on the entropy and the enthalpy.

5. The production planning device according to claim 4, wherein the distribution calculation unit calculates a sum and a variance of the predicted processing times for the plurality of production lines and, based on the calculated result, calculates a distribution pattern for distributing the plurality of types of articles included in the article list information to the respective production lines.

6. The production planning device according to claim 4, wherein, in each of the plurality of production lines,
in a case where the predicted processing time in each of the production lines is denoted by “Time_{pred}”, a predicted processing speed of the plurality of types of articles distributed to each of the production lines is dented by “v_{pred} ”, a maximum processing speed in each of the production lines is denoted by “vₘₐₓ ”, the enthalpy in each of the production lines is denoted by “H”, and Gibbs energy calculated from the entropy and the enthalpy in each of the production lines is denoted by “G”,
the time calculation unit calculates the predicted processing time such that the following formulas are satisfied:
$${Time}_{pred} = H / {v}_{pred}$$
$${v}_{pred} = {v}_{m ax} ( G / H ) .$$

7. The production planning device according to claim 5, wherein, in each of the plurality of production lines,
in a case where the predicted processing time in each of the production lines is denoted by “Time_{pred}”, a predicted processing speed of the plurality of types of articles distributed to each of the production lines is dented by “v_{pred} ”, a maximum processing speed in each of the production lines is denoted by “vₘₐₓ ”, the enthalpy in each of the production lines is denoted by “H”, and Gibbs energy calculated from the entropy and the enthalpy in each of the production lines is denoted by “G”,
the time calculation unit calculates the predicted processing time such that the following formulas are satisfied:
$${Time}_{pred} = H / {v}_{pred}$$
$${v}_{pred} = {v}_{m ax} ( G / H ) .$$

8. The production planning device according to claim 4, wherein, in each of the plurality of production lines,
in a case where the predicted processing time in each of the production lines is denoted by “Time_{pred}”, an ideal processing time in each of the production lines is dented by “Time_{ideal}”, a loss time in each of the production lines is denoted by “Timeₗₒₛₛ”, a total number of an i-th type of article among the plurality of types of articles to be distributed to the respective production lines is denoted by “Nᵢ”, a predicted processing speed of an i-th type of article among the plurality of types of articles to be distributed to the respective production lines is denoted by “vᵢ”, a coefficient of j-th parameter among a plurality of types of parameters specifying each of the plurality of types of articles to be distributed to the respective production lines is denoted by “Xⱼ”, and the entropy corresponding to a j-th parameter among the plurality of types of parameters is denoted by “Sⱼ”,
the time calculation unit calculates the predicted processing time such that the following formulas are satisfied:
$$\begin{matrix}{Time}_{pred} = {Time}_{ideal} + {Time}_{loss} \\ {Time}_{ideal} = \sum ( {N}_{i} / {v}_{i} ) \\ {Time}_{loss} = \sum {X}_{j} {S}_{j} .\end{matrix}$$

9. The production planning device according to claim 5, wherein, in each of the plurality of production lines,
in a case where the predicted processing time in each of the production lines is denoted by “Time_{pred}”, an ideal processing time in each of the production lines is dented by “Time_{ideal}”, a loss time in each of the production lines is denoted by“Timeₗₒₛₛ”, a total number of an i-th type of article of among the plurality of types of articles to be distributed to the respective production lines is denoted by “Nᵢ”, a predicted processing speed of an i-th type of article of among the plurality of types of articles to be distributed to the respective production lines is denoted by “vᵢ”, a coefficient of j-th parameter among a plurality of types of parameters specifying each of the plurality of types of articles to be distributed to the respective production lines is denoted by “Xⱼ”, and the entropy corresponding to a j-th parameter among the plurality of types of parameters is denoted by “Sⱼ”,
the time calculation unit calculates the predicted processing time such that the following formulas are satisfied:
$$\begin{matrix}{Time}_{pred} = {Time}_{ideal} + {Time}_{loss} \\ {Time}_{ideal} = \sum ( {N}_{i} / {v}_{i} ) \\ {Time}_{loss} = \sum {X}_{j} {S}_{j} .\end{matrix}$$

10. The production planning device according to claim 1, wherein
the article list information includes parameter information indicating at least one value of each of parameters, and the parameters are a plurality of types of parameters respectively specifying the plurality of types of articles,
the loss information includes, for every type of the at least one value of each of the parameters, the number of the at least one value, and
the distribution planning unit creates the distribution plan data based on entropy associated with the number of the at least one value for every type of the at least one value of each of a plurality of parameters included in the plurality of types of parameters.

11. The production planning device according to claim 10, further comprising:
a parameter extraction unit configured to extract a plurality of parameters from the plurality of types of parameters, based on correlation information between the plurality of types of parameters, wherein
the distribution planning unit creates the distribution plan data, based on entropy associated with the number of the at least one value for every type of the at least one value, for each of the parameters extracted by the parameter extraction unit.

12. The production planning device according to claim 11, wherein the parameter extraction unit extracts the parameter included in a second combination having a correlation coefficient lower than a correlation coefficient of a first combination among the plurality of types of parameters.

13. A production planning method comprising:
acquiring article list information including information regarding a plurality of types of articles; and
creating distribution plan data for distributing the plurality of types of articles included in the article list information to a plurality of production lines, based on entropy associated with loss information regarding loss of production process speed in each of the production lines.

14. A computer-readable recording medium storing a program for use in an electromagnetic environment analysis method, the program being executed by a processor and causing a computer to execute:
acquiring article list information including information regarding a plurality of types of articles; and
creating distribution plan data for distributing the plurality of types of articles included in the article list information to a plurality of production lines, based on entropy associated with loss information regarding loss of production process speed in each of the production lines.
